(19) United States
(12) Patent Application Publication
(10) Pub. No.: US 2025/0362699 A1
(43) Pub. Date: Nov. 27, 2025

(54) LOAD DRIVE CIRCUIT

(71) Applicant: WILL SEMICONDUCTOR (SHANGHAI) CO. LTD., SHANGHAI (CN)

(72) Inventor: HIROYUKI KIMURA, MIYAGI (JP)

(21) Appl. No.: 18/884,620

(22) Filed: Sep. 13, 2024

(30) Foreign Application Priority Data
May 24, 2024 (JP) 2024-084737

(51) Int. Cl. G05F 1/59

(52) U.S. Cl. CPC G05F 1/59

(57) ABSTRACT

[Problem to be solved] To perform a soft start by a relatively simple circuit.

[Solution] A load drive circuit includes an n-channel output transistor M13 of which the drain is connected to a power supply, and which applies an output from the source to a load 16 when the output is ON; and a soft start reference block 12 that applies a soft start voltage between the gate and the source of the output transistor in a predetermined period from when the output is started to be ON. The soft start reference block 12 applies, between the gate and the source of the output transistor, a soft start voltage corresponding to the gate-source voltage of a reference transistor through which a current from a current source is made to flow, and the size of the reference transistor is smaller than that of the output transistor.

### BACKGROUND OF THE INVENTION

### 1. Field of the Invention

The disclosure relates to a load drive circuit that drives a load by an n-channel transistor.

### 2. Description of the Related Art

Conventionally, a semiconductor integrated circuit incorporating a switch device that controls the drive of various loads such as a motor has been known. As the switch device, there are a high-side load switch arranged on the upstream side of a load and a low-side switch arranged on the downstream side of the load, and these switch devices are appropriately selected and used according to the application.

In addition, when a power transistor, for example, a MOSFET (Metal-Oxide-Semiconductor Field Effect Transistor) device, is used as the switch device, there are two options, that is, an n-channel transistor (NMOSFET) or a p-channel transistor (PMOSFET). The NMOS is suitable for applications where the supply current to the load is relatively large.

In a case of the high-side load switch, the gate voltage of the NMOS is required to be higher than an input power supply voltage for switching control of the NMOS. Therefore, a power supply with a higher voltage than the input power supply voltage is required. In many cases, such a high-voltage power supply is generally generated by a charge pump circuit.

### PRIOR ART DOCUMENTS

### Non-Patent Documents

[Non-patent document 1] ROHM Datasheet “2.0 A Current Load Switch ICs for Portable Equipment”

### SUMMARY OF THE INVENTION

### Problems to be Solved

Here, the power generated by the charge pump circuit is limited, and it is desirable that the control of the switch device has low power consumption. In addition, the high-side load switch may require a soft start function to prevent a surge current at the time of ON. Furthermore, the high-side load switch is an alternative to a mechanical relay and must handle loads with a variety of conditions, such as capacitive loads, inductive loads, and high-current loads.

Accordingly, there are various requirements for the high-side load switch.

### Means to Solve Problems

A load drive circuit related to the disclosure includes:
an n-channel output transistor of which the drain is connected to a power supply, and which applies an output from the source to a load when the output is ON; and
a soft start reference block that applies a soft start voltage between the gate and the source of the output transistor in a predetermined period from when the output is started to be ON; where
the soft start reference block applies, between the gate and the source of the output transistor, a soft start voltage corresponding to the gate-source voltage of a reference transistor through which a current from a current source is made to flow, and
the size of the reference transistor is smaller than that of the output transistor.

### Effect

According to the load drive circuit related to the disclosure, a soft start can be performed with low power consumption.

### BRIEF DESCRIPTION OF THE DRAWINGS

FIG. 1 is a circuit diagram showing the configuration of a load drive circuit according to an embodiment.

FIG. 2 is a timing chart showing the operation of the circuit of FIG. 1.

FIG. 3 is a diagram showing the relationship between an output current Iout at the time of soft start and a current I_vcp supplied from Vcp.

FIG. 4 is a diagram showing a waveform in a case where an output transistor is turned on without a soft start.

FIG. 5 is a diagram describing relative voltages between nodes in a circuit diagram of a full-on control block.

FIG. 6 is a timing chart showing the operation of the full-on control block.

FIG. 7 is a circuit diagram showing the configuration of a variation example.

### PREFERRED EMBODIMENT OF THE PRESENT INVENTION

Hereinafter, embodiments of the disclosure are described with reference to the drawings. Moreover, the following embodiments do not limit the scope of the disclosure, and configurations obtained by selectively combining multiple examples are also included in the disclosure.

### “Circuit Configuration”

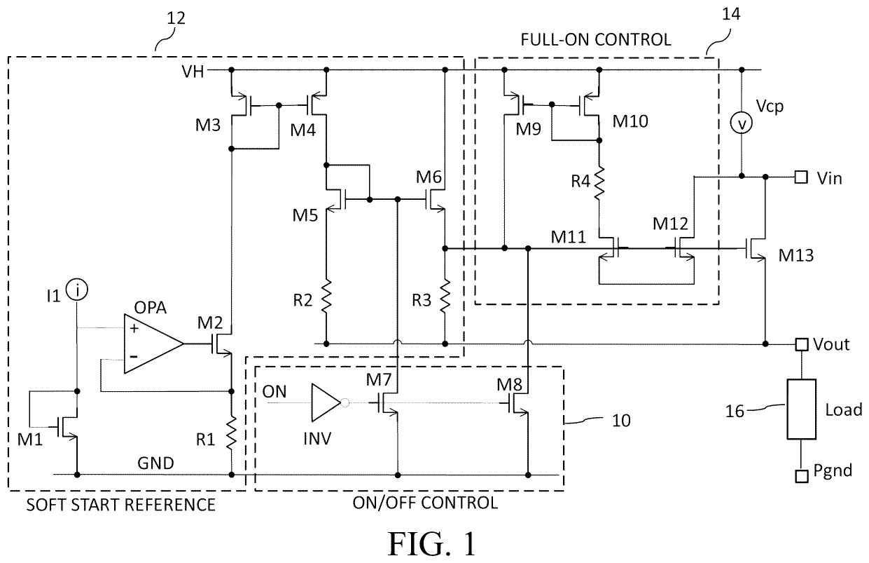

FIG. 1 is a circuit diagram showing the configuration of a load drive circuit according to an embodiment. As shown in the figure, the load drive circuit includes an on/off control block 10, a soft start reference block 12, a full-on control block 14, and an n-channel transistor M13, which is a power transistor that drives a load 16. The load drive circuit is preferably accommodated in a single semiconductor integrated circuit, for example, a LSI (large-scale integration). The transistor M13 is referred to as the output transistor.

In addition, the drive of the output transistor M13 is controlled by the output of the circuit. Moreover, the load 16 is driven by an output current of the output transistor M13. In addition, an output voltage Vout is supplied from the upper side of the load 16 (a connection point of the transistor M13 with the load 16).

### <Soft Start Reference Block>

A current source I1 outputs a constant current I1. The drain of an n-channel transistor M1 is connected to the downstream side of the current source I1, and the source of the transistor M1 is connected to a ground GND. In the transistor M1, there is a short between the gate and the drain, and the transistor M1 functions as a diode. Therefore, the constant current I1 flows through the transistor M1, and the voltage on the upstream side (the drain side) of the transistor M1 becomes Vgs of the transistor M1. It is preferable that the constant current I1 can be set arbitrarily.

The drain side of the transistor M1 is connected to the positive input end of an operational amplifier OPA. The output of the operational amplifier OPA is connected to the gate of an n-channel transistor M2. The source of the transistor M2 is connected to the ground GND via a resistor R1. A connection point of the resistor R1 with the source of a transistor M3 is connected to the negative input end of the operational amplifier OPA.

In addition, the drain of the transistor M2 is connected to the drain of the p-channel transistor M3, and the source of the transistor M3 is connected to a high-voltage power supply VH. In the transistor M3, there is a short between the gate and the drain, and the transistor M3 functions as a diode.

Therefore, the current flows from the high-voltage power supply VH to the ground GND via the transistor M3, the transistor M2, and the resistor R1. Besides, the operational amplifier OPA operates so that the voltage of the negative input end becomes the gate-source voltage Vgs_M1 of the transistor M1, which is the input voltage of the positive input end. Therefore, a current of I=Vgs_M1/R1 flows through the resistor R1 (set to a resistance value R1). The transistor M1 is referred to as a reference transistor.

The base of a p-channel transistor M4 is connected to the gate of the transistor M3, and the source of the transistor M4 is connected to the high-voltage power supply VH. Therefore, the transistor M3 and the transistor M4 constitute a current mirror.

The drain of an n-channel transistor M5 is connected to the drain of the transistor M4. The source of the transistor M5 is connected to an output end Vout via a resistor R2. In the transistor M5, there is a short between the gate and the drain, and the transistor M5 functions as a diode. Therefore, a current corresponding to the current flowing through the transistor M3 flows to the transistor M4, the transistor M5, and the resistor R2.

The gate of the transistor M5 is connected to the gate of an n-channel transistor M6. The drain of the transistor M6 is connected to the high-voltage power supply VH, and the source of the transistor M6 is connected to the output end Vout via a resistor R3. In addition, the gate of the output transistor M13 is connected to a connection point of the transistor M6 with the resistor R3. Therefore, the gate-source voltage of the output transistor M13 becomes a voltage corresponding to the voltage drop of the resistor R3.

Because the transistor M5 and the transistor M6 constitute a current mirror, a current corresponding to the current flowing through the transistor M5 flows through the transistor M6 and the resistor R3. When the ratio of the size of the transistor M3 to that of the transistor M4 is made to correspond to the ratio of the current flowing through the resistor R1 to the current flowing through the resistor R2, and the ratio of the size of the transistor M5 to that of the transistor M6 is made to correspond to the ratio of the current flowing through the resistor R2 to the current flowing through the resistor R3, the voltage drop of the resistor R3 is equal to that of the resistor R1, and thus the voltage drop at the resistor R3 is equal to Vgs_M1.

The voltage drop of the resistor R3 becomes the gate-source voltage (referred to as the soft start voltage) of the output transistor M13, and at this time, the current flowing through the output transistor M13 becomes a soft start current I_soft. Therefore, the gate-source voltage Vgs_M13 of the output transistor M13 can be determined according to the gate-source voltage Vgs_M1 of the transistor M1, and thereby the soft start current I_soft can be determined.

Therefore, the transistor M1 and the transistor M13 are assumed to have the same characteristics, and the sizes of the transistor M1 and the transistor M13 are set to a predetermined ratio. For example, the ratio of the size of the transistor M1 to that of the transistor M13 is set to n (n=M13/M1).

Here, the current of the transistor M13 at the time of soft start is set to I_soft. In order to make operating conditions consistent, the current flowing through the transistor M1, that is, I1, is set to I_soft/n. If the resistance values of the resistors R1, R2, and R3 are made the same, the voltage drop of the resistor R1 is equal to that of the resistor R3. In addition, the voltage drop of the resistor R1 becomes equal to Vgs_M1 by the operation of an OPA circuit. Therefore, Vgs_M1 is equal to Vgs_M13, and it becomes I_soft=I1*n.

Because each of the resistance values of the resistors R1, R2, and R3 can be selected arbitrarily, the current consumption I_vcp of Vcp can be suppressed by setting the resistance values to a large value.

Therefore, the soft start current I_soft can be determined according to the magnitude of the constant current I1 made to flow by the current source I1.

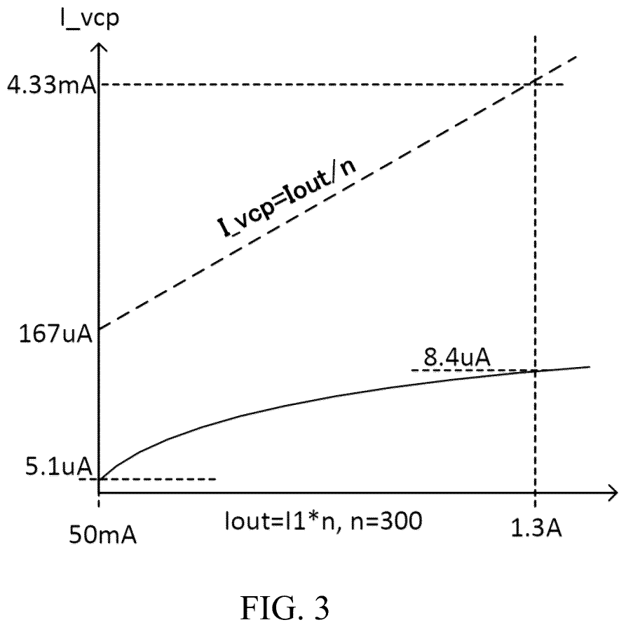

FIG. 3 is a diagram showing the relationship between the output current Iout=I_soft at the time of soft start and the current I_vcp supplied from Vcp, for example, in a case of n=300. The current is the current of the power supply Vcp and flows through the resistors R1, R2, and R3. As shown in the figure, I_vcp=5.1 uA and Vgs=1.7 V when Iout=50 mA, and I_vcp=8.4 μA and Vgs=2.8 V when Iout=1.3 A.

Accordingly, the soft start current is determined according to the gate-source voltage Vgs of the transistor M1, which has the same characteristics as the output transistor M13, and thus the soft start current can be easily set by the current set of the current source I1. In addition, the soft start reference block 12 can be made relatively small by the set of the sizes of the output transistor M13 and the transistor M1.

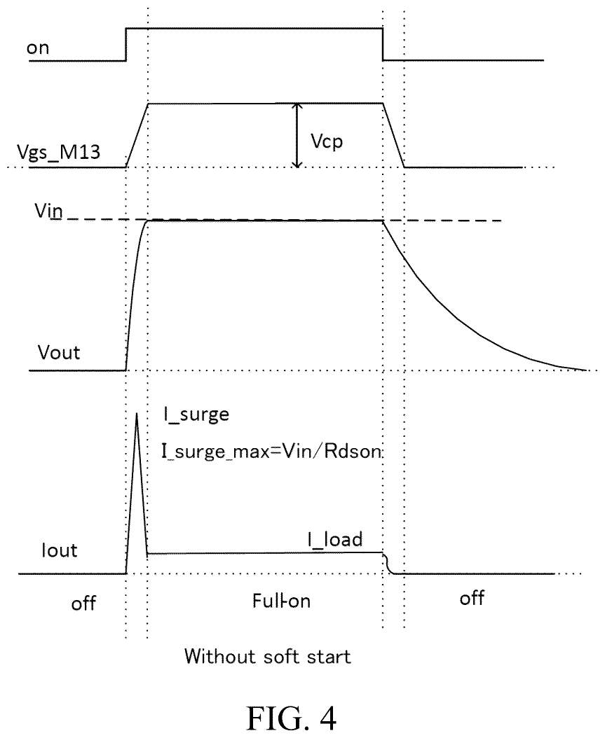

FIG. 4 is a diagram showing the waveform in a case where the output transistor M13 is turned on without a soft start. As shown in the figure, a large surge current I_surge flows at the start of the operation. The maximum value of the surge current is a value obtained by dividing an input voltage Vin by the on-resistance Rdson of the transistor M13, that is, I_surge_max=Vin/Rdson.

### <Full-on Control Block>

The drain of a p-channel transistor M9 is connected to the gate of M13. The source of the transistor M9 is connected to the high-voltage power supply VH.

A p-channel transistor M10 is connected to the gate of the transistor M9. Regarding the transistor M10, the source is connected to the high-voltage power supply VH, and there is a short between the gate and the source. Therefore, the transistor M10 and the transistor M9 constitute a current mirror.

The drain of the transistor M10 is connected to the drain of an n-channel transistor M11 via a resistor R4. The source of the transistor M11 is connected to the source of an n-channel transistor M12, and the drain of the transistor M12 is connected to an input end Vin of the input voltage Vin from the outside. In addition, a boosting power supply Vcp is arranged between the input end Vin and the high-voltage power supply VH. Therefore, the voltage of the high-voltage power supply VH becomes higher than the input voltage Vin by a boosted voltage Vcp.

As will be described later, when the input voltage Vin and the output voltage Vout are in a predetermined relationship, the voltage of the high-voltage power supply VH is higher than the input voltage Vin by the boosted voltage Vcp, and thus the current flows to the transistor M10, and the current flows toward the input end Vin via the resistor R4 and the transistors M11 and M12. Furthermore, a current corresponding to the current of the transistor M10 flows to the transistor M9, and the current flows toward the output end Vout via the resistor R3. Besides, the voltage drop at the resistor R3 becomes Vgs_M13 of the output transistor M13. Regarding the voltage Vgs_M13, the boosted voltage Vcp is determined in a manner that the output transistor M13 is fully ON. Therefore, when the full-on control block 14 is operating, the output transistor M13 is fully ON. The boosted voltage Vcp is referred to as the full-on voltage.

### <Output Part>

Not only the drain of the transistor M9, but also the gates of the transistors M11 and M12 and in addition the gate of the output transistor M13 are connected to the connection point of the transistor M6 with the resistor R3 in the soft start reference block 12. That is, the gates of the transistors M11, M12, and M13 are commonly connected to the connection point of the transistor M6 with the resistor R3.

In addition, as described above, the boosting power supply Vcp is arranged between the input end Vin and the high-voltage power supply VH, and the voltage of the high-voltage power supply VH is set to VH=Vin+Vcp. Moreover, the boosting power supply Vcp can be configured by a charge pump circuit and the like.

Besides, the source of the output transistor M13 becomes the output end Vout, and the output voltage Vout is applied to the load 16.

### <On/off Control Block>

Regarding the drive of the load 16, that is, the application of the output voltage Vout, an ON signal ON is supplied to the gates of an n-channel transistor M7 and an n-channel transistor M8 via an inverter INV. The drain of the transistor M7 is connected to the gate of the transistor M5 and the gate of the transistor M6, and the source of the transistor M7 is connected to the ground GND. The drain of the transistor M8 is connected to the gates of the transistor M11, the transistor M12, and the output transistor M13, and the source of the transistor M8 is connected to the ground GND.

Therefore, if the ON signal is ON (high level), the transistors M7 and M8 are OFF, and the soft start reference block 12 and the full-on control block 14 operate. On the other hand, if the ON signal is OFF (low level), the transistors M7 and M8 are ON, the transistors M5, M6, M11, M12, and M13 all become OFF, and the operations of the soft start reference block 12 and the full-on control block 14 are stopped.

### <About Operation>

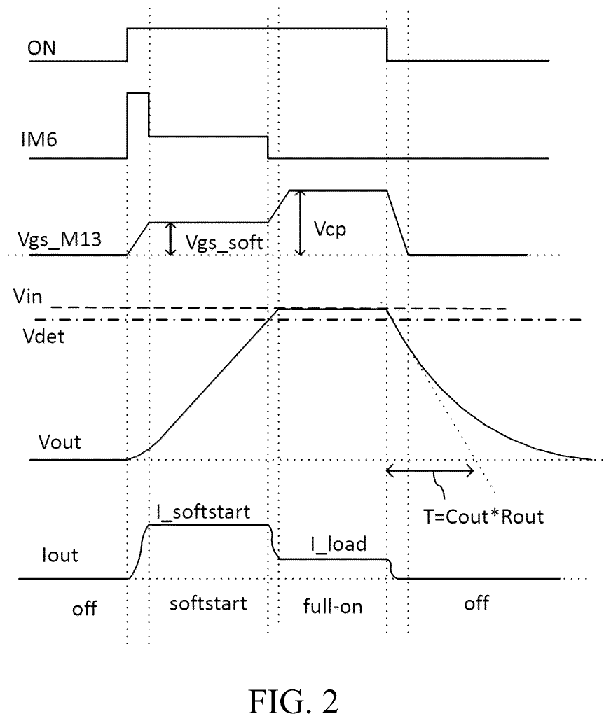

FIG. 2 is a timing chart showing the operation of the circuit of FIG. 1. When the ON signal ON becomes the high level (the output is ON), the soft start reference block 12 starts operation.

By the control of the operational amplifier OPA, the current mirror operation of the transistor M3 and the transistor M4, and the current mirror operation of the transistor M5 and the transistor M6, the voltage drop of the resistor R3 becomes close to Vgs_M1. Owing to the gate capacitance charging of the transistor M13, the current of the transistor M6 becomes greater than a specified value.

When the charging period of the gate capacitance ends, the current of the transistor M6 flows to the resistor R3, and the current becomes Vgs_M1/R3. Vgs_soft is generated by the voltage drop of the resistor R3 due to the current, and the output current is controlled to I_softstart. In the soft start section, the voltage of Vgs_M13 is constant.

In this state, the charging of the capacitance component of the load 16 is continued, and the output voltage Vout gradually increases.

Besides, when Vout increases and the difference of Vin, that is, the drain-source voltage of the transistor M13 becomes a predetermined small value, a detection voltage Vdet, which is the voltage obtained by subtracting the gate-source voltage of the transistor M11 from the gate-source voltage of the transistor M13, that is, the difference between Vout and the voltage of the source of the transistor M11, becomes a predetermined value. Thereby, the current starts to flow to the transistor M11 and the transistor M12. Therefore, the current flows to the transistor M10, and the current flowing from the transistor M9 to the resistor R3 also starts to flow.

Furthermore, when Vout becomes further close to Vin, the voltage drop at the resistor R3 becomes Vcp due to the current flowing through the transistor M9. Therefore, the gate-source voltage of the transistor M13 becomes Vcp, and the transistor M13 is fully ON. At this time, a load current I_load at the time of full-on flows to the load 16.

When the ON signal ON becomes the low level (the output is OFF), the transistors M7 and M8 are ON, and thereby the voltage supply to the gate of the output transistor M13 stops. Therefore, the output transistor M13 is OFF and no output current Iout is caused, and thus the output voltage Vout gradually becomes 0 as the current from Cout decreases. Moreover, the time constant t of the decrease in the output voltage Vout is t=Cout*Rout. Here, Cout is the capacitance of the load 16, and Rout is the resistance of the load 16.

Moreover, in the embodiment, as described above, the operation of the full-on control block 14 is started by the detection voltage Vdet, but a predetermined period of soft start may also be determined by measuring a predetermined time by using a timer from when the output is ON or comparing the voltage value of the output Vout with a predetermined value, as long as the surge current to the load 16 can be prevented. Besides, after a predetermined period has elapsed, the output transistor M13 is fully turned on by the full-on control block 14.

### <Full-on Control>

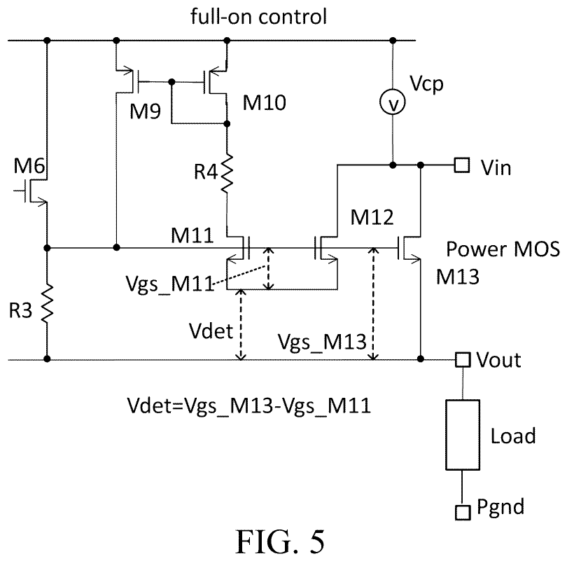

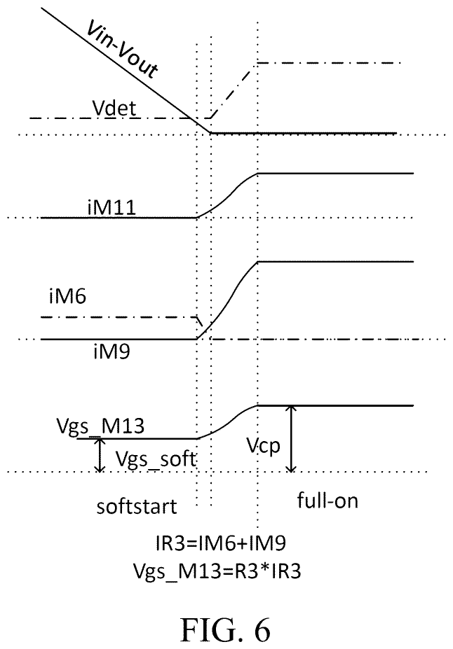

Here, the operation of the full-on control block 14 is described based on FIG. 3 and FIG. 4. FIG. 5 is a diagram describing relative voltages between nodes in a circuit diagram of the full-on control block 14. FIG. 6 is a timing chart showing the operation of the full-on control block 14.

As shown in FIG. 5, the difference between the gate-source voltage Vgs_M13 of the transistor M13 and the gate-source voltage of the transistor M11 is set to be the detection voltage Vdet (Vdet=Vgs_M13−Vgs_M11).

When the output voltage Vout is low, if an initial value of the source voltage of the transistor M12 is equal to the ground GND, the source voltage of the transistor M12 increases towards the input voltage Vin and becomes OFF when it increases until Vgs_M12=Vt (threshold voltage). Moreover, the gate-source voltage Vgs_M12 of the transistor M12 is OFF from the beginning if its initial value is the threshold voltage Vt. Because the gate-source voltage Vgs_M11 of the transistor M11 is equal to the gate-source voltage Vgs_M12 of the transistor M12, the transistor M11 also becomes OFF similarly.

Furthermore, when the output voltage Vout increases, the gate voltages of the transistors M11, M12, and M13 also increase, and the gate voltages become higher than the input voltage Vin. Besides, because the drain-source voltage Vds_M12 of the transistor M12 is close to 0 V, the source voltages of the transistors M11 and M12 become the same as the input voltage Vin.

Furthermore, when the output voltage Vout becomes close to the input voltage Vin, Vds of the transistor M12 becomes smaller and Vgs of the transistor M11 becomes larger than Vt, and thus the current flows via the transistor M10 and the resistor R4 and via the transistors M11 and M12.

In this way, when the gate-source voltage of the transistor M12 is equal to the threshold voltage (Vgs_M12=Vt) thereof, although no current flows through the resistor R4, when the output voltage Vout increases, the gate voltage of the transistor M13 increases while the gate-source voltage Vgs_M13 of the transistor M13 remains constant. Therefore, the gate of the transistor M12, which is commonly connected to the gate of the transistor M13, of which the voltage also increases, and becomes higher than the input voltage Vin. Furthermore, when the gate voltage of the transistor M12 increases, the drain-source voltage Vds_M12 of the transistor M12 becomes 0. Besides, when the drain-source voltage Vds_M12 of the transistor M12 becomes negative, the current flows from the resistor R4 side.

When the transistors M11 and M12 are sufficiently ON, the drain-source voltages Vds_M11 and Vds_M12 thereof become almost zero. Therefore, the sources and the drains of the transistors M11 and M12 become the same voltage as the input voltage Vin. Moreover, in fact, because the drain-source voltages Vds_M11 and Vds_M12 of the transistors M11 and M12 depend on the ratio of the on-resistances Rdson of the transistors M11 and M12 to the resistance R4, the condition of Vds_M11=Vds_M12=0 is Rdson<<R4.

In this way, the current flows through the transistor M10, and thereby the current flows through the transistor M9. Accordingly, the voltage of the resistor R3 becomes greater than the voltage of the resistor R2, the gate-source voltage of the transistor M5 becomes greater than the gate-source voltage of the transistor M6, it becomes Vgs_M5>Vgs_M6, and the current of the transistor M6 decreases. Furthermore, when the difference increases, the gate-source voltage of the transistor M6 becomes less than the threshold value, that is, Vgs_M6<Vt, and the transistor M6 is OFF.

Moreover, it is assumed that the on-resistance of the transistor M9 is sufficiently smaller than the resistance value of the resistor R3 (Rdson<<R3). In this case, the current of the transistor M9 becomes Vcp/R3, which is the current flowing through the resistor R3. In addition, by the current flowing through the resistor R4, the absolute value of the gate-source voltage Vgs_M10 of the transistor M10 increases, and the transistor M9 becomes ON, and the resistance value of the transistor M9 becomes sufficiently smaller than the resistor R3. Therefore, it is preferable that the relationship between the resistance values of the resistor R4 and the resistor R3 is R4>R3, and the relationship between the sizes of the transistor M9 and the transistor M10 is M9>M10.

### Variation Example

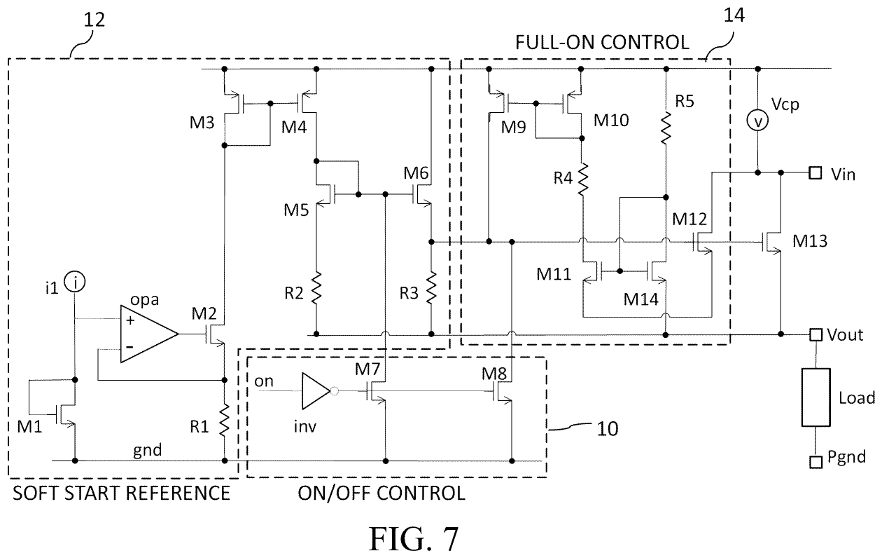

FIG. 7 is a schematic diagram showing the configuration of the variation example. In the variation example, a transistor M14 and a resistor R5 are added to the circuit of FIG. 1.

One end of the resistor R5 is connected to the high-voltage power supply VH, and the drain of the n-channel transistor M14 is connected to the other end of the resistor. In the transistor M14, there is a short between the gate and the drain. Besides, the gate of the transistor M14 is connected to the gate of the transistor M11, and the source of the transistor M14 is connected to the output end Vout.

In such a circuit, when the output voltage Vout becomes close to the input voltage Vin and the difference between Vgs_M11 of the transistor M11 and Vgs_M14 of the transistor M14 becomes the detection voltage Vdet, the transistor M11 becomes ON, and thereby the current flows to the transistor M10 and the transistor M9 via the transistor M11, and at the time point when the output voltage becomes almost equal to the input voltage (Vout=Vin), the gate-source voltage Vgs_M13 of the transistor M13 becomes Vgs_M13=Vcp, and the transistor M13 is fully ON.

In this way, in the circuit, the detection voltage Vdet is defined by the difference between Vgs_M11 of the transistor M11 and Vgs_M14 of the transistor M14, and is independent of Vgs_M13 of the transistor M13, which varies with the soft start current. Therefore, more accurate full-on control can be achieved.

### Effect of Embodiment

According to the embodiment, the soft start current is temporarily converted to a current proportional to Vgs of the reference transistor M1, which is arranged on the low side. Therefore, the current consumption of the circuit for controlling the soft start current can be reduced.

In addition, the output current of the transistor M13, which is a large power MOS transistor, can be detected by detecting the difference between the output voltage Vout and the input voltage Vin, and thus the current conversion ratio at the output can be widely selected.

In addition, because the soft start control starts automatically when the power supply is ON, it can be reliably performed without being affected by the configuration of the load 16 and the like.

Furthermore, by setting Vgs_M13 of the output transistor M13 to the boosted voltage Vcp set in advance and maintaining Vds of the output transistor M13 at almost 0 V, operation in a full-on mode can be achieved.

### REFERENCE SIGNS LIST

10 on/off control block
12 soft start reference block
14 full-on control block
16 load

What is claimed is:

1. A load drive circuit, comprising:
an n-channel output transistor of which the drain is connected to a power supply, and which applies an output from the source to a load when the output is ON; and
a soft start reference block that applies a soft start voltage between the gate and the source of the output transistor in a predetermined period from when the output is started to be ON; wherein
the soft start reference block applies, between the gate and the source of the output transistor, a soft start voltage corresponding to the gate-source voltage of a reference transistor through which a current from a current source is made to flow, and
the size of the reference transistor is smaller than that of the output transistor.

2. The load drive circuit according to claim 1, wherein
the reference transistor has similar characteristics to the output transistor.

3. The load drive circuit according to claim 1, wherein
the soft start reference block applies a soft start voltage between the gate and the source of the output transistor by making a current corresponding to the gate-source voltage of the reference transistor flow through a resistor arranged between the gate and the source of the output transistor.

4. The load drive circuit according to claim 1, wherein
a predetermined period from when the output is started to be ON is a period until the gate-source voltage of the output transistor reaches a predetermined value after the output is ON.

5. The load drive circuit according to claim 1, further comprising
a full-on control block that applies a full-on voltage between the gate and the source of the output transistor after a predetermined period has elapsed from when the output is started to be ON.

6. The load drive circuit according to claim 5, wherein
the full-on control block applies a full-on voltage between the gate and the source of the output transistor by making a predetermined current flow through a resistor arranged between the gate and the source of the output transistor.
